(19) United States
(12) Patent Application Publication
(10) Pub. No.: US 2022/0379786 A1
(43) Pub. Date: Dec. 1, 2022

(54) METHOD OF MANUFACTURING VENTILATION SHEET FOR VEHICLE

(71) Applicants: Hyundai Motor Company, Seoul (KR); Kia Corporation, Seoul (KR); KOONGLOTECH, Inc., Seoul (KR)

(72) Inventors: Sang Hyeok Yun, Ulsan (KR); Hye Min Lee, Suwon (KR); Sang Do Park, Suwon (KR); Sung Hak Hong, Suwon (KR); Chang Jae Lee, Daegu (KR); Kyung Hye Lee, Gumi (KR)

(21) Appl. No.: 17/739,822

(22) Filed: May 9, 2022

(30) Foreign Application Priority Data
May 26, 2021 (KR) 10-2021-0067768

(51) Int. Cl. B60N 2/58; B60N 2/56; B29C 70/22; B29C 70/88

(52) U.S. Cl. CPC B60N 2/5891; B60N 2/5621; B29C 70/224; B29C 70/88; B29K 2105/0026

(57) ABSTRACT

Disclose are is method of manufacturing a ventilation sheet for a vehicle. The ventilation sheet for a vehicle is manufactured by performing anti-fouling finishing treatment using an anti-fouling coating agent including an anti-fouling composition. The anti-fouling properties can be improved to prevent the sheet from being fouled, and flame-retardant treatment is performed through a flame-retardant aqueous solution including flame-retardant PET fiber and flame retardant in bath so that the deterioration of flame retardancy caused by the improved anti-fouling properties can be prevented through the flame-retardant treatment while ventilation properties are maintained.

### CROSS REFERENCE TO RELATED APPLICATION

The present application claims priority to Korean Patent Application No. 10-2021-0067768, filed May 26, 2021, the entire contents of which are incorporated herein for all purposes by this reference.

### TECHNICAL FIELD

The present invention relates to a method of manufacturing a ventilation sheet for a vehicle and a ventilation sheet for a vehicle manufactured by this method.

### BACKGROUND

A sheet used for an interior material of an existing vehicle is a component with which a passenger's body is in direct contact, and various research and development are being made to solve discomfort caused by the body contact and to realize a comfortable ride.

Particularly, in order to prevent sweat from forming on a contact surface between a passenger's body and a sheet in hot weather and to enhance comfort, a ventilation sheet for a vehicle, which is connected to an air conditioner of the vehicle, i.e., an air conditioning device to deliver cool air to the passenger's body, is applied.

In the related art, a conventional ventilation sheet for a vehicle may be problematic in that its fouling is not effectively prevented. Thus, a method of preventing the fouling of the sheet and thereby enhancing anti-fouling properties has been reported.

For example, in order to provide flame retardancy to the ventilation sheet for the vehicle, a method of coating the sheet with a flame retardant has been provided in that the flow of air through the ventilation sheet for the vehicle is obstructed.

The foregoing is intended merely to aid in the understanding of the background of the present invention, and is not intended to mean that the present invention falls within the purview of the related art that is already known to those skilled in the art.

### SUMMARY

In preferred aspects, provide are a method of manufacturing a ventilation sheet for a vehicle and a ventilation sheet for a vehicle manufactured by this method. In particular, a flame-retardant PET fiber may be included in the ventilation sheet, and anti-fouling finishing treatment and flame-retardant treatment are performed under specific conditions.

The present invention is not limited to the above-mentioned objective. Other objectives of the present invention may be evidently understood from the following description, and may be realized by means described in claims and combinations thereof.

In an aspect, provided is a method of manufacturing a ventilation sheet for a vehicle. The method may include preparing a base layer including flame-retardant polyethylene terephthalate (PET) fiber, or PET fiber; positioning an intermediate layer including PET fiber on the base layer; and positioning a surface layer including PET composite fiber on the intermediate layer. Each of the base layer and the surface layer may be formed to have a mesh-net structure including holes, and the PET composite fiber may include PET fiber and flame-retardant PET fiber.

The method may further include performing anti-fouling finishing treatment and/or performing flame-retardant treatment.

A thickness of the flame-retardant PET fiber or the PET fiber included in the base layer may suitably range from about 75 to about 100 De (Denier).

A thickness of the PET fiber included in the intermediate layer may suitably range from about 20 to about 30 De (Denier).

A thickness of the PET composite fiber included in the surface layer may suitably range from about 300 to about 450 De (Denier).

The ventilation sheet may suitably include the flame-retardant PET fiber in an amount of about 50 to 85 wt %, on the basis of the total weight of the ventilation sheet.

The ventilation sheet may suitably include an amount of about 50 to 75 wt % of the flame-retardant PET fiber in the surface layer and an amount of about 0 to 10 wt % of the flame-retardant PET fiber in the base layer, on the basis of the total weight of the ventilation sheet.

In the performing the anti-fouling finishing treatment, treatment may be performed with an anti-fouling coating agent including an anti-fouling composition in an amount greater than about 3 wt % and less than about 7 wt % on the basis of the total weight of the anti-fouling coating agent.

The term “anti-fouling finishing treatment” as used herein refers to a process performed to prevent attachment or adhesion of contaminants on a surface of a subject, e.g., metal surface, polymeric surface, and the like, by physical or chemical treatment on the surface. Exemplary anti-fouling finishing treatment may include applying a coating material (e.g., anti-fouling coating agent) on the surface.

The anti-fouling composition may suitably include an amount of about 3 to 7 wt % fluorine-resin based antifouling agent and an amount of about 2 to 5 wt % isocyanate-based cross-linking agent, on the basis of the total weight of the anti-fouling composition.

In the performing the flame-retardant treatment, treatment may be performed with a flame-retardant aqueous solution including a flame-retardant in an amount greater than about 3 wt % and less than about 10 wt % on the basis of the total weight of the flame-retardant aqueous solution.

The term “flame retardant treatment” as used herein refers to a process performed to prevent burning or reduce development of ignition by physical or chemical treatment on the surface. Exemplary flame retardant treatment may include applying a coating material (e.g., flame-retardant agent or aqueous solution) on the surface.

In an aspect, provided is a ventilation sheet for a vehicle. The ventilation sheet may include a base layer including flame-retardant polyethylene terephthalate (PET) fiber; an intermediate layer positioned on the base layer, and including PET fiber; and a surface layer positioned on the intermediate layer, and including PET composite fiber. Each of the base layer and the surface layer may be formed to have a mesh-net structure including holes, and the PET composite fiber may include PET fiber and flame-retardant PET fiber.

The ventilation sheet may be subjected to anti-fouling finishing treatment and/or flame-retardant treatment.

The ventilation sheet may suitably include the flame-retardant PET fiber in an amount of about 50 to 85 wt %, on the basis of the total weight of the ventilation sheet.

The ventilation sheet may suitably include an amount of about 50 to 75 wt % of the flame-retardant PET fiber in the surface layer and an amount of about 0 to 10 wt % of the flame-retardant PET fiber in the base layer, on the basis of the total weight of the ventilation sheet.

The anti-fouling finishing treatment may be performed with an anti-fouling coating agent including an anti-fouling composition in an amount greater than about 3 wt % and less than about 7 wt % on the basis of the total weight of the anti-fouling coating agent, water, and a dispersant.

The flame-retardant treatment may be performed with a flame-retardant aqueous solution including a flame-retardant in an amount greater than about 3 wt % and less than about 10 wt % on the basis of the total weight of the flame-retardant aqueous composition.

A size of each of the holes of the surface layer may suitably range from about 0.8 to about 8 mm, and a number of the holes of the surface layer may suitably range from about 40 to about 250 EA/inch.

Air permeability caused by the holes may suitably range from about 150 to about 180 cm³/cm²/s.

According to various exemplary embodiments, the ventilation sheet may include flame-retardant PET fiber, and anti-fouling finishing treatment and flame-retardant treatment may be performed to manufacture the ventilation sheet for the vehicle, thus maintaining ventilation properties, improving anti-fouling properties for preventing sheet fouling, and preventing flame retardancy from being deteriorated.

In a further aspect, a ventilation sheet is provided that is obtainable from a method as disclosed herein.

In a yet further aspect, a ventilation sheet is provided that is obtained from a method as disclosed herein.

Vehicles are also provided that comprise a ventilation sheet as disclosed herein. The present invention is not limited to the above-mentioned effects. It should be understood that the present invention includes all effects that may be inferred from the following description.

Other aspects of the invention are disclosed infra.

### BRIEF DESCRIPTION OF THE DRAWINGS

The above and other objectives, features, and other advantages of the present invention will be more clearly understood from the following detailed description when taken conjointly with the accompanying drawings, in which:

FIG. 1 shows an exemplary method of manufacturing an exemplary ventilation sheet for a vehicle according to an exemplary embodiment of the present invention; and

FIG. 2 shows a state in which air transmitted from a ventilation fan passes through a ventilation sheet for a vehicle according to an exemplary embodiment of the present invention.

### DETAILED DESCRIPTION OF THE INVENTION

The above and other objectives, features, and advantages of the present invention will be easily understood from the following preferred embodiments in conjunction with the accompanying drawings. However, the invention may be embodied in different forms without being limited to the embodiments set forth herein. Rather, the embodiments disclosed herein are provided to make the invention thorough and complete and to sufficiently convey the spirit of the present invention to those skilled in the art.

Like reference numerals refer to like parts throughout various figures and embodiments of the present invention. The sizes of elements in the accompanying drawings may be exaggerated for clarity of illustration.

It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof. Furthermore, when a first part such as a layer, a film, a region, or a plate is disposed on a second part, the first part may be not only directly on the second part but a third part may be interposed between them. To the contrary, when a first part such as a layer, a film, a region, or a plate is under a second part, the first part may be not only directly under the second part but a third part may be interposed between them. Unless specified otherwise, since all numbers, values and/or expressions expressing quantities of components, reaction conditions, polymer compositions, and blends that are used herein are essentially approximations that reflect various uncertainties in the measurement that may occur in obtaining these values among others, it should be understood that these expressions are modified by the term “about”. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles. hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Furthermore, when a numerical range is disclosed herein, the range is continuous, and all values from a minimum value to a maximum value of this range are included unless otherwise indicated. Moreover, when this range refers to an integer, all integers from the minimum value to the maximum value of this range are included unless otherwise indicated.

Herein, when a range is stated for a variable, it is to be understood that the variable includes all values in the range including endpoints of the range. For example, it is to be understood that the range of “5 to 10” includes values of 5, 6, 7, 8, 9, and 10, any sub-ranges such as 6 to 10, 7 to 10, 6 to 9, or 7 to 9, and any values between the integers in the above-described range such as 5.5, 6.5, 7.5, 5.5 to 8.5 and 6.5 to 9. Furthermore, for example, it is to be understood that the range of “10% to 30%” includes all integers such as 10%, 11%, 12%, 13%, or 30%, any sub-ranges such as 10% to 15%, 12% to 18%, or 20% to 30%, and any values between the integers in the above-described range such as 10.5%, 15.5%, or 25.5%.

A conventional ventilation sheet for a vehicle is low in anti-fouling properties. Further, if the sheet is coated with a flame retardant to provide flame retardancy to the ventilation sheet for the vehicle, as in the conventional method, there occurs a problem in which the flow of air through the ventilation sheet for the vehicle is obstructed.

Provided is a ventilation sheet that may include a surface layer containing flame-retardant PET fiber and a base layer containing only flame-retardant PET fiber are used. The surface layer and the base layer may be included in specific contents, and anti-fouling finishing treatment and flame-retardant treatment may be performed under specific conditions to manufacture a ventilation sheet for a vehicle. This sheet may maintain ventilation properties, improve anti-fouling properties for preventing sheet fouling, and prevent flame retardancy from being deteriorated.

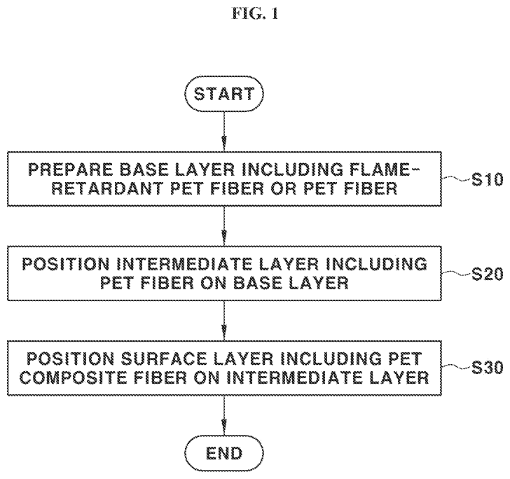

FIG. 1 shows an exemplary method of manufacturing an exemplary ventilation sheet for a vehicle according to an exemplary embodiment of the present invention. The method of manufacturing the ventilation sheet for the vehicle according to the present invention includes a step S10 of preparing a base layer containing flame-retardant polyethylene terephthalate (PET) fiber, a step S20 of positioning an intermediate layer containing the PET fiber on the base layer, and a step S30 of positioning a surface layer containing PET composite fiber on the intermediate layer. The method may further include a step S40 of performing anti-fouling finishing treatment and/or a step S50 of performing flame-retardant treatment.

The base-layer preparing step S10 may be the step of preparing the base layer as a support layer for preparing the ventilation sheet for the vehicle.

Since the base layer includes flame-retardant PET fiber, and the content of the flame-retardant PET fiber of the base layer may vary depending on the content of the flame-retardant PET fiber of the PET composite fiber in the surface layer, the content of the base layer may be adjusted. In particular, the ventilation sheet for the vehicle may include the flame-retardant PET fiber in the PET composite fiber in a content adjusted in the surface layer and the base layer so that it is possible to maintain anti-fouling properties and ventilation properties while preventing flame retardancy from being deteriorated.

Particularly, on the basis of the total weight of the ventilation sheet, the ventilation sheet may include the flame-retardant PET fiber in an amount from about 50 to about 85 wt %. Preferably, the ventilation sheet may include an amount of about 50 to 75 wt % of the flame-retardant. PET fiber in the surface layer and an amount of about 0 to 10 wt % of the flame-retardant PET fiber in the base layer.

For instance, depending on the content of the flame-retardant PET fiber in the surface layer, a ratio of the base layer containing only the flame-retardant PET fiber to the laminated sheet for the interior material of the vehicle may vary. When the content of the flame-retardant PET fiber in the surface layer is high so that flame-retardant PET fiber in the base layer is not required, the ratio of the base layer may be reduced. Further, when the flame-retardant PET fiber is not required in the base layer, the PET fiber may be substituted for the flame-retardant PET fiber. In contrast, when the content of the flame-retardant PET fiber in the surface layer is relatively small so that the flame-retardant PET fiber in the base layer is required, the ratio of the base layer may be increased.

Preferably, the ventilation sheet may include the base layer in an amount of about 6 to 13 wt %, in an amount of about 9 to 11 wt %, and or in an amount of about 10 to 11 wt %, on the basis of 100 wt % of the ventilation sheet. When the content of the base layer is less than the predetermined amount, e.g., less than about 6 wt %, strength may decrease and balance between the base layer and the surface layer may be broken, thus resulting in poor shape stability. When the content of the base layer is greater than the predetermined amount, e.g., greater than about 13 wt %, the air permeability of a back side may be reduced, thus leading to a reduction in the amount of air flowing to the surface layer.

The base layer may be in a form to have a mesh-net structure including holes. Since the base layer is a part at which air blown from a ventilation fan arrives first, the base layer may be preferably designed to allow a lot of air to move to the surface layer.

Therefore, in order to cause a large amount of air to move to the surface layer without blocking, the denier of yarn forming the base layer may be preferably less than the denier of yarn forming the surface layer. When the yarn thickness of the base layer is formed to be less than that of the surface layer so that the number of holes of the base layer is more than that of holes of the surface layer, air may maximally move from the back layer to a surface without blocking. Furthermore, in order to cause a large amount of air to move to the surface layer without blocking, the size of the holes formed in the base layer is preferably larger than the size of the holes formed in the surface layer.

Thus, according to various exemplary embodiments of the present invention, the thickness of the PET fiber or the PET composite fiber included in the base layer may range from about 75 to about 100 denier (De). When the thickness is too thin, the strength of fabric may be reduced. When the thickness is too thick, ventilation performance may be deteriorated. Furthermore, the size of the hole may range from about 0.8 to about 8 mm, and the number of holes may range from about 40 to about 250 EA/inch. When the size of the hole is less than the predetermined size, e.g., less than about 0.8 mm, the air permeability may be deteriorated. When the size of the hole is greater than the predetermined size, e.g., greater than about 8 mm, the shape stability may be deteriorated. Furthermore, when the number of the holes is less than the predetermined range, e.g., less than about 40 EA/inch, the air permeability may be deteriorated. When the number of the holes is greater than the predetermined range, e.g., greater than about 250 EA/inch, the binding force of fabric may be reduced and thus the shape stability may be deteriorated.

The step S20 of positioning the intermediate layer on the base layer may include the step of positioning the intermediate layer containing the PET fiber on the prepared base layer.

The intermediate layer may be a layer connecting the surface layer and the base layer, and may be a layer that determines the thickness of the ventilation sheet for the vehicle. Thus, since air transfer speed is slowed down if the thickness of the ventilation sheet for the vehicle is thick, the intermediate layer is preferably made as thin as possible. The thickness of the intermediate layer for satisfying both the comfort of a passenger and the durability preferably ranges from about 2 to about 8 mm. When the thickness of the intermediate layer is less than the predetermined value, e.g., less than about 2 mm, cushioning ability may be deteriorated and vent holes of the fabric may be clogged by a driver's load. When the thickness of the intermediate layer is greater than about the predetermined value, e.g., greater than about 8 mm, the transfer of air to the driver is delayed.

The PET fiber may include the fiber forming the intermediate layer because the PET fiber does not hinder ventilation. Furthermore, the PET fiber may have a connecting structure in an “11” shape rather than an “x” shape. The “x” shape is not suitable because fibers arranged in the “x” shape overlap each other to hinder the flow of air and thereby deteriorate the air permeability. Furthermore, the thickness of the fiber included in the intermediate layer may be less than that of the fiber used in the base layer and the surface layer to prevent the flow or air from being obstructed and thereby prevent the air permeability from being deteriorated. The thickness of the PET fiber included in the intermediate layer may range from about 20 to about 30 De. When the thickness of the PET fiber is not within this range and is less than the predetermined value, e.g., less than about 20 De, the connection of the surface layer and the base layer may become weak. On the other hand, when the thickness is greater than the predetermined value, e.g., greater than about 30 De, the fiber obstructs the ventilation so that air may not be smoothly transferred.

Meanwhile, as the fibers of the intermediate layer are arranged in the “11” shape, a slip may occur between the surface layer and the base layer, as compared to the “x” shape. In order to prevent such a problem, it is preferable to design the fabric of the sheet at a high density. Since the density of the fabric is related to the size of the hole, the size of the hole may range from about 0.8 to about 8 mm, and the number of holes may range from about 40 to about 250 EA/inch. When the size of the hole is not within this range and is less than the predetermined size, e.g., less than about 0.8 mm, the ventilation performance may be deteriorated. When the size of the hole is greater than the predetermined range, e.g., greater than about 8 mm, the binding force of the fabric may be decreased, thus deteriorating the shape stability. Furthermore, when the number of the holes is less than the predetermined range, e.g., less than about 40 EA/inch, the ventilation performance may be deteriorated. When the number of the holes is greater than the predetermined range, e.g., greater than about 250 EA/inch, the shape stability may be deteriorated due to a reduction in strength and a slip.

The intermediate layer may be included in the ratio of about 6 to 13 wt % on the basis of the total weight of the ventilation sheet for the vehicle. When the content of the intermediate layer is less than the predetermined value, e.g., less than about 6 wt %, the connection strength of the surface layer and the base layer may become weak. When the content of the intermediate layer is greater than the predetermined value, e.g., 13 wt %, the ventilation performance may be deteriorated.

The step S30 of positioning the surface layer on the intermediate layer may include the step of positioning the surface layer containing the PET composite fiber on the intermediate layer positioned on the base layer.

The surface layer and the base layer may prevent flame retardancy from being deteriorated by adjusting the content of the flame-retardant PET fiber of the PET composite fiber in the surface layer. The ventilation sheet may be produced by adjusting the content of the flame-retardant PET fiber in the PET composite fiber of the surface layer and the base layer, anti-fouling properties and ventilation properties may be maintained while preventing flame retardancy from being deteriorated.

Particularly, on the basis of the total weight of the ventilation sheet, the ventilation sheet may include the flame-retardant PET fiber in an amount of about 50 to 85 wt %. Preferably, the ventilation sheet may include an amount of about 50 to 75 wt % of the flame-retardant PET fiber in surface layer and an amount of about 0 to 10 wt % of the flame-retardant PET fiber of the base layer.

Preferably, the surface layer may be included in the ratio of about 75 to 88 wt %, about 79 to 82 wt %, or particularly about 80 to 81 wt %, on the basis of the total weight of the ventilation sheet. When the content of the surface layer is less than the predetermined amount, e.g., 75 wt %, wear resistance may be deteriorated. When the content of the surface layer is greater than about 88 wt %, ventilation performance may be deteriorated.

Depending on the content of the flame-retardant PET fiber in the surface layer, the content of the above-described base layer may be adjusted. Specific details are the same as those described above.

Thus, the PET composite fiber contained in the surface layer may include an amount of about 2 to 9 wt % PET fiber and an amount of about 91 to 98 wt % flame-retardant PET fiber, on the basis of the entire surface layer of 100 wt %. When the content of the PET fiber is less than the predetermined amount, e.g., less than about 2 wt %, strength as well as elongation may be reduced. When the content of the PET fiber is greater than the predetermined amount, e.g., greater than about 9 wt %, flame retardancy may be deteriorated. Furthermore, when the content of the flame-retardant PET fiber is less than the predetermined amount, e.g., less than about 91 wt %, flame retardancy may be deteriorated. When the content of the flame-retardant PET fiber is greater than the predetermined amount, greater than about 98 wt %, the content of the PET fiber may be reduced so that strength may be reduced and elongation may be reduced.

The surface layer may be in a form to have a mesh-net structure including holes. Since the surface layer is in direct contact with a passenger's body, high durability may be required and simultaneously air supplied from the base layer should be transmitted to the passenger without being lost from the surface layer. Thus, the structure of the surface layer should have both a high-density region that does not allow air to pass therethrough, and a hole region that allows air to easily pass therethrough, unlike the base layer. Such a structure prevents air from flowing through the high-density region to some extent, and allows air to intensively flow out through the hole region, thus improving ventilation performance.

In order to make the surface layer of such a structure, the thickness of yarn forming the surface layer may be preferably greater than that of yarn forming the back layer. The thickness of the yarn forming the surface layer may be preferably in the range of about 300 to 450 De. When the thickness is less than the predetermined range, e.g., less than about 300 De, surface wear resistance may be deteriorated. When the thickness is greater than the predetermined range, e.g., greater than about 450 De, the hole may be reduced, thus deteriorating ventilation performance. Further, the size of the holes of the surface layer may range from about 0.8 to about 8 mm, and the number of the holes may range from about 40 to about 250 EA/inch. When the size of the holes is less than the predetermined size, e.g., less than about 0.8 mm, ventilation performance may be deteriorated. When the size of the holes is greater than the predetermined size, e.g., greater than about 8 mm, the binding force of the fabric may be reduced, thus leading to a reduction in strength. Furthermore, when the number of the holes is less than the predetermined value, e.g., less than about 40 EA/inch, ventilation performance may be deteriorated. When the number of the holes is greater than the predetermined value, e.g., greater than about 250 EA/inch, shape stability may be deteriorated.

Furthermore, the method of manufacturing the ventilation sheet for the vehicle according to the present invention may further include the step S40 of performing anti-fouling finishing treatment on the laminated ventilation sheet for the vehicle, and/or the step S50 of performing the flame-retardant treatment, thus manufacturing the ventilation sheet for the vehicle.

Preferably, the additional treatment steps may include the anti-fouling finishing treatment and the flame-retardant treatment, and the sequence of the treatment steps is not particularly limited. The anti-fouling finishing treatment and the flame-retardant treatment may be sequentially performed, or the flame-retardant treatment and the anti-fouling finishing treatment may be sequentially performed.

The step S40 of performing the anti-fouling finishing treatment may include the step of additionally performing the anti-fouling finishing on the laminated ventilation sheet for the vehicle.

The entire laminated ventilation sheet for the vehicle may be treated with an anti-fouling coating agent including an anti-fouling composition for the purpose of the anti-fouling treatment. The anti-fouling coating agent may include an anti-fouling composition, a solvent, a dispersant, and the like. Preferably, the anti-fouling composition may be included in the anti-fouling coating agent in an amount greater than about 3 wt % and less than about 7 wt %, based on the total weight of the anti-fouling coating agent. When the content of the anti-fouling composition is less than the predetermined amount, e.g., less than about 3 wt %, the anti-fouling properties may become non-uniform and performance may be deteriorated. When the content of the anti-fouling composition is greater than the predetermined amount, e.g., greater than about 7 wt %, anti-fouling performance may be excellent but flame retardancy may be deteriorated.

The anti-fouling composition may contain various components to which anti-fouling properties are imparted, for example, an antifouling agent, a cross-linking agent, and the like. The antifouling agent may use various compositions for imparting the anti-fouling properties to the fabric, and may include one or more kinds selected from a group including a fluorine-resin based antifouling agent, and silicon-based and urethane-based antifouling agents, for example. In particular, the fluorine-resin based antifouling agent having excellent thermal resistance is preferred.

Furthermore, the cross-linking agent may use melamine-based and isocyanate-based agents that are well known to those skilled in the art. In particular, the isocyanate-based cross-linking agent capable of improving abrasion resistance is preferred.

The anti-fouling composition may include an amount of about 3 to 7 wt % fluorine-resin based. antifouling agent and an amount of about 2 to 5 wt % isocyanate-based cross-linking agent, on the basis of the total weight of the anti-fouling composition. When the content of the antifouling agent is less than the predetermined amount, e.g., less than about 3 wt %, the anti-fouling performance may be deteriorated. When the content of the antifouling agent is greater than the predetermined amount, e.g., greater than about 7 wt %, the flame retardancy may be deteriorated. Furthermore, when the content of the cross-linking agent is less than the predetermined amount, e.g., less than about 2 wt %, the anti-fouling properties may become non-uniform. When the content of the cross-linking agent is greater than the predetermined amount, e.g., greater than about 5 wt %, flame retardancy and light-fastness may be deteriorated.

Meanwhile, a predetermined amount of antistatic agent may be further added to the anti-fouling composition to prevent static electricity and enhance antistatic properties in the fabric.

Furthermore, the step of performing the anti-fouling finishing treatment may further perform a dehydration process of removing water from the ventilation sheet for the vehicle that is subjected to the anti-fouling finishing treatment, and the fabric may be dehydrated in various ways. Furthermore, the step of performing the anti-fouling finishing treatment may further perform a drying process for further reducing the percentage of water content in the ventilation sheet for the vehicle that is subjected to the anti-fouling finishing treatment.

Since the method of manufacturing the ventilation sheet for the vehicle according to the present invention is intended to manufacture the ventilation sheet for the vehicle by performing the anti-fouling finishing treatment with the anti-fouling coating agent containing a specific content of anti-fouling composition, ventilation properties can be maintained, anti-fouling properties can be improved to prevent the sheet from being fouled, and the deterioration of flame retardancy caused by the improved anti-fouling properties can be prevented through the flame-retardant treatment that is subsequently performed.

The step S50 of performing the flame-retardant treatment may include the step of further performing the flame-retardant treatment on the laminated ventilation sheet for the vehicle.

In the ventilation sheet for the vehicle, a ventilation structure that allows air discharged from the ventilation fan under a seat frame to be smoothly transmitted to a driver is important. However, when the ventilation sheet for the vehicle is coated with a flame-retardant material to secure the flame retardancy, this obstructs the flow of air. Thus, it is impossible to apply a general flame-retardancy reinforcing method to the vehicle sheet, i.e., it is impossible to employ back flame-retardant component coating (application).

Thus, the flame-retardant treatment may perform the flame-retardant treatment by treating a flame retardant in bath rather than by a coating method so as to enhance the flame retardancy. Particularly, after a predetermined amount of flame-retardant aqueous solution is put into a dyeing machine, the flame retardant penetrates into the fiber at high temperature and at high pressure, the flame retardant in bath may be treated so that the flame-retardant treatment may be performed.

The flame retardant in bath may include general components that may be used in the present invention, for example, one or more kinds selected from a group including a powder type and an emulsion type each having phosphorus as the main component. This is not limited to the flame retardant containing only a specific component.

The flame-retardant treatment may be performed using the flame-retardant aqueous solution containing the flame retardant in bath. Preferably, the flame-retardant treatment may be performed using the flame-retardant aqueous solution including the flame retardant. The flame-retardant aqueous solution may include the flame retardant in an amount greater than about 3 wt % and less than about 10 wt % based on the total weight of the flame-retardant aqueous solution. When the content of the flame retardant is less than the predetermined amount, e.g., less than about 3 wt %, the flame retardancy may be deteriorated. When the content of the flame retardant in bath is greater than the predetermined amount, e.g., greater than about 10 wt %, light stability may be deteriorated.

Since the method of manufacturing the ventilation sheet for the vehicle according to the present invention performs the flame-retardant treatment through the flame-retardant aqueous solution containing a specific content of flame retardant in bath and includes a specific content of flame-retardant PET fiber, deterioration in flame retardancy caused by the improved anti-fouling properties is prevented.

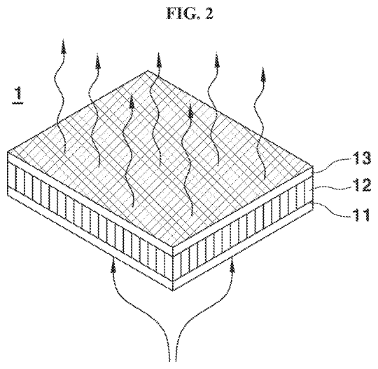

FIG. 2 shows a state in which the air transmitted from the ventilation fan passes through the ventilation sheet for the vehicle according to an embodiment of the present invention. As shown in FIG. 2, the ventilation sheet may include a base layer 11 including flame-retardant polyethylene terephthalate (PET) fiber, an intermediate layer 12 positioned on the base layer and including PET fiber, and a surface layer 13 positioned on the intermediate layer and including PET composite fiber. Each of the base layer and the surface layer may be formed to have a mesh-net structure including holes, and the PET composite fiber includes PET fiber and flame-retardant PET fiber. In particular, the ventilation sheet for the vehicle may be subjected to the step of performing the anti-fouling finishing treatment and/or the step of performing the flame-retardant treatment.

The description of each layer of the ventilation sheet for the vehicle and an additional treatment step may be the same as the above description.

That is, the air permeability due to the holes of the ventilation sheet may range from about 150 to about 180 cm³/cm²/s. In other words, air blown from the sheet circulating ventilation fan may easily flow through the holes, formed in the base layer and called a “mesh”, to the holes of the surface layer, thus allowing air to be smoothly transmitted to a passenger. Furthermore, the ventilation sheet for the vehicle according to the present invention has a lot of space due to a three-dimensional structure as compared to a conventional flat structure so that the amount of airflow increases, air circulation of the fabric itself is excellent, and the temperature of the fabric may be lowered while air stays in the fabric, and thereby it is advantageous to lower the temperature of the sheet.

Therefore, the ventilation sheet for the vehicle according to various exemplary embodiments of the present invention may be manufactured by performing the anti-fouling finishing treatment with the anti-fouling coating agent containing the anti-fouling composition in a specific content, thus improving the anti-fouling properties for preventing the sheet from being fouled, and is subjected to the flame-retardant treatment using the flame-retardant aqueous solution containing the flame-retardant PET fiber in a specific content and containing the flame retardant in bath in a specific content, thus maintaining ventilation properties while preventing deterioration of the flame retardancy caused by the improved anti-fouling properties.

### EXAMPLE

Hereinafter, the embodiments of the present invention will be described in detail. The following embodiments are merely illustrative to aid in understanding the present invention, and the scope of the present invention is not limited thereto.

### Embodiment 1 and Embodiment 2, Comparative Example 1 to Comparative Example 5: Manufacture of Ventilation Sheet for Vehicle

After compositions according to the following fable 1 were applied to respective layers and the layers were stacked, they were subjected to the anti-fouling finishing treatment and the flame-retardant treatment, thus manufacturing the ventilation sheet for the vehicle.

TABLE 1

| | | | | | | Flame-retardant | |
|---|---|---|---|---|---|---|---|
| | Ventilation sheet | | | | | treatment | |
| | for vehicle | | | Anti-fouling | | | Treatment |
| | | Interme- | | finishing | | Flame- | of flame |
| | Surface | diate | Base | Surface | | retardant | retardant in |
| Type | layer | layer | layer | treatment | Immersion | PET fiber | bath |
| Comparative | PET fiber | PET | PET | No | Anti-fouling | No | Treatment |
| example 1 | 100% | fiber | fiber | | composition | | (5%) |
| | | 100% | 100% | | treatment | | |
| | | | | | (7%) | | |
| Comparative | PET fiber | PET | PET | No | Anti-fouling | No | Treatment |
| example 2 | 100% | fiber | fiber | | composition | | (10%) |
| | | 100% | 100% | | treatment | | |
| | | | | | (7%) | | |
| Comparative | PET fiber | PET | PET | Resin | No | No | Treatment |
| example 3 | 100% | fiber | fiber | treatment | | | (10%) |
| | | 100% | 100% | (20%) | | | |
| Embodiment 1 | PET | PET | Flame- | No | Anti-fouling | Yes | Treatment |
| | composite | fiber | retardant | | composition | | (5%) |
| | fiber | 100% | PET | | treatment | | |
| | (PET | | fiber | | (5%) | | |
| | fiber 5 | | 100% | | | | |
| | wt %, | | | | | | |
| | flame- | | | | | | |
| | retardant | | | | | | |
| | PET fiber | | | | | | |
| | 95%) | | | | | | |
| | Total flame-retardant PET | | | | | | |
| | fiber content = 86 wt % | | | | | | |
| Comparative | PET | PET | Flame- | No | Anti-fouling | Yes | Treatment |
| example 4 | composite | fiber | retardant | | composition | | (5%) |
| | fiber | | PET | | treatment | | |
| | (PET | | fiber | | (5%) | | |
| | fiber 95 | | 100% | | | | |
| | wt %, | | | | | | |
| | flame- | | | | | | |
| | retardant | | | | | | |
| | PET fiber | | | | | | |
| | 5 wt %) | | | | | | |
| | Total flame-retardant PET | | | | | | |
| | fiber content = 14 wt % | | | | | | |
| Embodiment 2 | PET | PET | PET | No | Anti-fouling | Yes | Treatment |
| | composite | fiber | fiber | | composition | | (5%) |
| | fiber | 100% | 100% | | treatment | | |
| | (PET | | | | (5%) | | |
| | fiber 5 | | | | | | |
| | wt %, | | | | | | |
| | flame- | | | | | | |
| | retardant | | | | | | |
| | PET fiber | | | | | | |
| | 95 wt %) | | | | | | |
| | Total flame-retardant PET | | | | | | |
| | fiber content = 76 wt % | | | | | | |
| Comparative | PET | PET | PET | No | Anti-fouling | Yes | treatment |
| example 5 | composite | fiber | fiber | | composition | | (3%) |
| | fiber | 100% | 100% | | treatment | | |
| | (PET | | | | (5%) | | |
| | fiber 5 | | | | | | |
| | wt %, | | | | | | |
| | flame- | | | | | | |
| | retardant | | | | | | |
| | PET fiber | | | | | | |
| | 95 wt %) | | | | | | |

Total flame-retardant PET
fiber content = 76 wt %

* Ratio of respective layers in ventilation sheet of vehicle: surface layer 80.1%, intermediate layer 9.5%, base layer 10.4%
* Anti-fouling surface treatment: anti-fouling agent is applied to only a side of the ventilation sheet for the vehicle that is used (no anti-fouling component is applied to a back side)
* Anti-fouling resin immersion: method of wetting the entire ventilation sheet for the vehicle with the anti-fouling coating agent
* Anti-fouling composition (on the basis of the total anti-fouling composition of 100 wt %): fluorine-resin based antifouling agent of 5 wt %, isocyanate-based cross-linking agent of 3 wt %
* flame retardant in bath of 5 wt %

Criteria for Judgment
Air permeability (cm³/cm²/s): 150
Anti-fouling: H.KMC MS standard (MS 320-20 4.9) anti-fouling grade “B” or higher is required.

TABLE 2

| | Water repellency | | Oil repellency | | |
|---|---|---|---|---|---|
| Type | State | After wear | State | After wear | Use agent |
| Anti-fouling A | 6^{th} grade ↑ | 5^{th} grade ↑ | 4^{th} grade ↑ | 2^{nd} grade ↑ | water/oil repelling agent |
| Anti-fouling B | 6^{th} grade ↑ | — | — | — | water repelling agent |
| Anti-fouling C | 3^{rd} grade ↑ | — | — | — | water repelling agent |

| | |
|---|---|
| Test method | Test with standard reagent for each water/oil repelling grade |
| | After 30 seconds, droplet evaluation is performed in the same manner (Grade A to C) |
| | Durability: after wear |

Decontamination: H.KMC standard (MS 320-20 4.10) (Six types of contaminants: artificial sweat, black coffee, milk, Coke, grape juice→4^{th} grade ↑, Ketchup 3^{rd} grade ↑)

TABLE 3

| Type | Use agent |
|---|---|
| Anti-fouling A | artificial sweat, black coffee, milk, Coke, grape juice, Ketchup (4^{th} grade↑), |
| | cooking oil (3^{rd} grade↑) |
| Anti-fouling B | artificial sweat, black coffee, milk, Coke, grape juice, Ketchup(4^{th} grade↑) |
| Anti-fouling C | artificial sweat, black coffee, milk, Coke, grape juice(4^{th} grade↑), Ketchup(2^{nd} |
| | grade↑) |
| Test method | Place contamination agent on specimen and lightly press same with glass rod |
| | After leaving it for one hour, cotton cloth is wetted with fabric cleaner and |
| | fabric cleaner is removed |
| | After completely drying same, perform evaluation; |
| | perform evaluation based on AATTC 130 decontamination standard plate(1^{st} to |
| | 5^{th} grade) |

Flame-retardancy pass: flame-retardant rate 80 mm/min or less

Evaluation Result

According to Embodiment 1, Embodiment 2. and Comparative example 1 to Comparative example 5, the ventilation sheet for the vehicle was manufactured, the manufactured ventilation sheet for the vehicle was evaluated according to the evaluation criteria, and then the evaluation result was shown in the following table 4.

TABLE 4

| | | | Decontamination | |
|---|---|---|---|---|
| | Air | | (Six types of | |
| | permeability | Anti-fouling | contamination | Flame-retardancy |
| Type | (cm³/cm²/s) | result | sources) | result |
| Comparative Example 1 | 190 | Pass | Pass | Failure |
| Comparative Example 2 | 190 | Pass | Pass | Failure |
| Comparative Example 3 | 190 | Failure | Pass | Pass |
| Embodiment 1 | 190 | Pass | Pass | Pass |
| Comparative Example 4 | 180 | Pass | Pass | Failure |
| Embodiment 2 | 180 | Pass | Pass | Pass |
| Comparative Example 5 | 180 | Pass | Pass | Failure |

*Six types of contamination sources: artificial sweat, black coffee, milk, Coke, grape juice → 4^{th} grade↑, Ketchup 3^{rd} grade

As shown in Tables 1 to 4, in the case of the ventilation sheet for the vehicle according to Comparative Example 1 in which the surface layer and the base layer which do not contain the PET composite fiber containing the flame-retardant PET fiber were subjected to the anti-fouling finishing and flame-retardant treatment, the air permeability and the anti-fouling properties were satisfied, but the flame retardancy was deteriorated because the flame-retardancy result shows failure.

Furthermore, as compared to comparative example 1, in the case of the ventilation sheet for the vehicle according to Comparative Example 2 in which the flame-retardant treatment was performed with the flame-retardant aqueous solution having the content of the flame retardant in bath increased to 10%, the air permeability and the anti-fouling properties were satisfied, but the flame retardancy was deteriorated because the flame-retardancy result showed failure even if the content of the flame retardant in bath increased.

Thus, as compared to Comparative Example 2, in the case of the ventilation sheet for the vehicle according to Comparative Example 3 in which the anti-fouling finishing was performed with the anti-fouling coating agent containing the anti-fouling composition of 20% not through immersion but through surface treatment, the flame retardancy was satisfied but the anti-fouling properties were not satisfied. Because the anti-fouling treatment was performed on only a surface and no flame-retardant treatment was performed on a back side, uniform anti-fouling performance was not achieved.

In Comparative Example 1 to Comparative Example 3, both the anti-fouling properties and the flame retardancy were not satisfied simply by the flame-retardant treatment or the anti-fouling finishing treatment. Thus. Embodiment 1, Embodiment 2, Comparative Example 4, and Comparative Example 5 conducted experiments for satisfying the flame retardancy and the anti-fouling properties by including the flame-retardant PET fiber in each of the surface layer and the base layer.

Particularly, in the case of the ventilation sheet for the vehicle according to Embodiment 1, the surface layer including the composite PET fiber containing the flame-retardant PET fiber of 95 wt % and the base layer including the flame-retardant PET fiber were included in a specific ratio, and the anti-fouling finishing treatment and the flame-retardant treatment that were the same as those of comparative example 1 were performed. As such, both the anti-fouling properties and the flame retardancy were satisfied.

However, as compared to Embodiment 1, the ventilation sheet for the vehicle according to Comparative Example 4 in which the surface layer was made to include the composite PET fiber containing a small amount of flame-retardant PET fiber did not satisfy the flame retardancy. Thus, the flame-retardant PET fiber in the composite PET fiber of the surface layer should be included at a specific ratio or more.

Meanwhile, as compared to embodiment 1, the ventilation sheet for the vehicle according to Embodiment 2 in which the base layer did not include the flame-retardant PET fiber and only the surface layer included the flame-retardant PET fiber satisfies the anti-fouling properties and the flame retardancy. The flame-retardant PET fiber may not be included in the base layer, if a large amount of flame-retardant PET fiber is included in the surface layer.

Finally, as compared to Embodiment 2, the ventilation sheet for the vehicle according to Comparative Example 5 in which the flame-retardant treatment was performed with the flame-retardant aqueous solution having the content of the flame retardant in bath. reduced to 3% did not satisfy the flame retardancy. Thus, in order to satisfy the flame retardancy, the flame-retardant treatment should. be performed with the flame-retardant aqueous solution containing the flame retardant in bath having the content which is more than 3% and less than 10%.

As described above, a ventilation sheet for a vehicle according to various exemplary embodiments of the present invention may be manufactured by performing anti-fouling finishing treatment using an anti-fouling coating agent containing a specific content of anti-fouling composition so that anti-fouling properties can be improved to prevent the sheet from being fouled. Moreover, flame-retardant treatment may be performed through a flame-retardant aqueous solution containing a specific content of flame-retardant PET fiber and a specific content of flame retardant in bath so that the deterioration of flame retardancy caused by the improved anti-fouling properties can be prevented through the flame-retardant treatment while ventilation properties are maintained.

What is claimed is:

1. A method of manufacturing a ventilation sheet for a vehicle, comprising:
preparing a base layer comprising a flame-retardant polyethylene terephthalate (PET) fiber or PET fiber;
disposing an intermediate layer comprising a PET fiber on the base layer; and
disposing a surface layer comprising a PET composite fiber on the intermediate layer,
wherein each of the base layer and the surface layer is formed to have a mesh-net structure comprising holes, and
wherein the PET composite fiber comprises PET fiber and flame-retardant PET fiber.

2. The method of claim 1, further comprising performing anti-fouling finishing treatment, and/or performing flame-retardant treatment.

3. The method of claim 1, wherein a thickness of the flame-retardant PET fiber or the PET fiber included in the base layer ranges from 75 to 100 De (Denier).

4. The method of claim 1, wherein a thickness of the PET fiber included in the intermediate layer ranges from 20 to 30 De (Denier).

5. The method of claim 1, wherein a thickness of the PET composite fiber included in the surface layer ranges from 300 to 450 De (Denier).

6. The method of claim 1, wherein the ventilation sheet comprises the flame-retardant PET fiber in an amount of 50 to 85 wt %, on the basis of the total weight of the ventilation sheet.

7. The method of claim 6, wherein the ventilation sheet comprises an amount of 50 to 75 wt % of the flame-retardant PET fiber in the surface layer and an amount of 0 to 10 wt % of the flame-retardant PET fiber in the base layer, on the basis of the total weight of the ventilation.

8. The method of claim 2, wherein, in the performing the anti-fouling finishing treatment, treatment is performed with an anti-fouling coating agent comprising an anti-fouling composition in an amount greater than 3 wt % and less than 7 wt % on the basis of the total weight of the anti-fouling coating agent.

9. The method of claim 8, wherein the anti-fouling composition comprises an amount of 3 to 7 wt % of fluorine-resin based antifouling agent and an amount of 2 to 5 wt % of isocyanate-based cross-linking agent, on the basis of the total weight of the anti-fouling composition

10. The method of claim 2, wherein, in the performing the flame-retardant treatment, treatment is performed with a flame-retardant aqueous solution comprising a flame-retardant in an amount greater than 3 wt % and less than 10 wt % base on the basis of the total weight of the flame-retardant aqueous composition.

11. A ventilation sheet for a vehicle, comprising:
a base layer comprising flame-retardant polyethylene terephthalate (PET) fiber;
an intermediate layer positioned on the base layer, and comprising PET fiber; and
a surface layer positioned on the intermediate layer, and comprising PET composite fiber,
wherein each of the base layer and the surface layer is formed to have a mesh-net structure including holes, and
wherein the PET composite fiber comprises PET fiber and flame-retardant PET fiber,

12. The ventilation sheet of claim 11, wherein the ventilation sheet is subjected to anti-fouling finishing treatment and/or flame-retardant treatment.

13. The ventilation sheet of claim 11, wherein the ventilation sheet comprises the flame-retardant PET fiber in an amount of 50 to 85 wt %, on the basis of the total weight of the ventilation sheet.

14. The ventilation sheet of claim 13, wherein the ventilation sheet comprises an amount of 50 to 75 wt % of the flame-retardant PET fiber in the surface layer and an amount of 0 to 10 wt % of the flame-retardant PET fiber in the base layer, on the basis of the total weight of the ventilation sheet.

15. The ventilation sheet of claim 12, wherein the anti-fouling finishing treatment is performed with an anti-fouling coating agent comprising an anti-fouling composition that is more than 3 wt % and less than 7 wt % on the basis of the total weight of the anti-fouling coating agent, water, and a dispersant.

16. The ventilation sheet of claim 12, wherein the flame-retardant treatment is performed with a flame-retardant aqueous solution comprising a flame-retardant in an amount greater than 3 wt % and less than 10 wt % on the basis of the total weight of the flame-retardant aqueous composition.

17. The ventilation sheet of claim 11, wherein a size of each of the holes of the surface layer ranges from 0.8 to 8 mm, and a number of the holes of the surface layer ranges from 40 to 250 EA/inch.

18. The ventilation sheet of claim 11, wherein air permeability caused by the holes ranges from 150 to 180 cm³/cm²/s.

19. A ventilation sheet obtainable of obtained from a method of claim 1.

20. A vehicle comprising a ventilation sheet of claim 11.
